(19) United States
(12) Patent Application Publication
(10) Pub. No.: US 2019/0008019 A1
(43) Pub. Date: Jan. 3, 2019

(54) METHOD OF CONTROLLING A LIGHT INTENSITY OF A LIGHT SOURCE IN A LIGHT NETWORK

(71) Applicants: Guy Le Hénaff, Montréal (CA); Yves Le Hénaff, Toulouse (FR)

(72) Inventors: Guy Le Hénaff, Montréal (CA); Yves Le Hénaff, Toulouse (FR)

(21) Appl. No.: 16/064,388

(22) PCT Filed: Dec. 21, 2016
(86) PCT No.: PCT/CA2016/051518

§ 371 Date: Jun. 20, 2018

Related U.S. Application Data
(60) Provisional application No. 62/270,244, filed on Dec. 21, 2015.

(51) Int. Cl. H05B 37/02

(52) U.S. Cl. CPC H05B 37/0227; H05B 37/0245; H05B 37/0236

(57) ABSTRACT

There is described a method for controlling a light intensity of a given light source in a light network comprising other light sources. The method comprises providing a detector having a field of view (FOV) and operably connected to the given light source for controlling a light intensity of the given light source. The method further comprises using the detector to detect if there is a change, according to a first pattern, in a light intensity of at least one of the other light sources, thereby detecting that a neighbor became a master. In response to detecting such a change, the light intensity of the given light source is changed according to a second pattern, thereby becoming a slave. The detector can also detect if there is a movement in the FOV, in which case light intensity of the given light source is changed according to the first pattern, thereby becoming a master.

### FIELD

The subject matter disclosed generally relates to street lighting systems. More specifically, it relates to light apparatuses that selectively light up street light.

### BACKGROUND

Most street lighting involves light poles which are lit up at dawn when sunlight is insufficient and turned off in the morning when sunlight is back again. For example, they may be set to be turned on and off at specific times in the day depending on the calendar.

Continuously keeping street lights on during the whole night across a city is energy consuming. Since most streets are usually empty in the middle of the night, the continuous lighting of the streets uses high amounts of energy uselessly.

Therefore, there is a need for a street lighting system that selectively lights up only when necessary, i.e., only when vehicles and pedestrians are passing by a light pole. For safety and comfort, it is preferable if lights are lit up on the area of moving objects (pedestrians, vehicles), but also in their surroundings. There is thus also a need for a system that would provide lighting to the surroundings of a moving object, but not further. There is also a need to anticipate the next areas of interest that will need to be illuminated.

Moreover, modern systems often involve embarked computer power and some degree of connectivity between computing devices. This connectivity is associated with a greater vulnerability to hacking. Since municipal infrastructures are critical for the safety and comfort of its inhabitants, there is a need for a street lighting system that is designed to impede, prevent, or at least mitigate the risk of hacking. There is therefore a need for a communication channel between light poles that is not prone to hacking.

Furthermore, municipal administrations often lack the budget or expertise to implement technologically complex systems into their infrastructures and maintain them. The proposed solution should also cost less than the savings resulting from the lower energy consumption. There is thus a need for a solution to the issues mentioned above that is easy to care, i.e., a light apparatus that can be incorporated into a light pole as easily as a light bulb, and that involves low-complexity and low-cost hardware components.

Additionally, there is a need for a system that, according to an embodiment, could discriminate different types of objects, such as vehicles, pedestrians or animals, without the use of technological devices such as RFIDs, and that could provide a lighting that is more appropriate to the object that is detected (in this case, road lighting, sidewalk lighting and no lighting, respectively).

Existing systems that aim at providing a dynamic lighting (that would be lit up only when necessary) either use simple devices that do not communicate together, or complex systems that cost too much, consume too much energy, or are connected to a communication network and vulnerable to hacking.

### SUMMARY

In traditional light poles, a light pole typically comprises the pole itself, a light fixture (comprising a socket) at the top of the pole and a light source mounted within the light fixture. Other components can be added to increase functionality but need not be discussed herein. Light poles described herein further comprise a light apparatus (in addition to usual components) which can perform various detection and light control functions. The embodiments use these detection and light control functions to enable communication. This requirement of at least minimal communication capabilities between light apparatuses comes from the need to light not only the areas where movement is perceived, but also the neighboring areas. Indeed, pedestrians need to feel safe while walking in the streets and it is thus preferable to have neighboring light poles turned on, and not only the closest one to the pedestrian.

According to one aspect, there is provided a method for controlling a light intensity of a given light source in a light network comprising other light sources, the method comprising: providing a first detector and a second detector operably connected to the given light source, the first detector having a field of view (FOV), the second detector having a detection range; configuring the given light source to change the light intensity in accordance with a first pattern and a second pattern; using the first detector, detecting a change according to a first pattern, in a light intensity of at least one of the other light sources; in response to detecting the change, changing the light intensity of the given light source according to a second pattern; wherein upon detecting a movement within the detection range using the second detector, changing light intensity of the given light source according to the first pattern.

In another aspect, there is provided an apparatus for controlling a light intensity of a given light source in a light network comprising other light sources, the apparatus comprising: a camera having a field of view (FOV) and being configured for acquiring images of the FOV; a control unit, operably connected to the camera and to the given light source, for controlling the light intensity of the given light source, the control unit being adapted to: receive images of the FOV from the camera and analyze the received images for performing at least one of: detecting a movement in the FOV; and detecting a change, according to a first pattern, in the light intensity of the at least one of the other light sources; and upon detecting a movement in the FOV, change light intensity of the given light source according to light sources, change the light intensity of the given light source according to a second pattern.

In a further aspect, there is provided a system for controlling a network of light sources, the system comprising:
a plurality of apparatuses, each one of the apparatuses being installed on a corresponding one of the light sources and being to control a light intensity of the corresponding one of the light sources in accordance with a first pattern and a second pattern, wherein each one of the light sources has a field of illumination (FOI); and each one of the apparatuses has a field of view (FOV) substantially covering the FOI of the corresponding one of the light sources and covering at least in part the FOI of at least another one of the light sources; each one of the apparatuses comprising:
a first detector adapted to detect a movement inside its FOV;
a second detector adapted to detect a change according to the first pattern in the FOI of the at least another one of the light sources;
a controller operably connected to the first detector, to the second detector, and to the corresponding one of the light sources, the controller being adapted to:
   upon detecting a movement in the FOV, change the light intensity of the corresponding one of the light sources according to the first pattern; and
   upon detecting a change, according to the first pattern, in the light intensity of the at least another one of the light sources, change the light intensity of the corresponding one of the light sources according to a second pattern.

In yet a further aspect, there is provided an apparatus for controlling a light intensity of a given light source in a light network comprising other apparatuses, the apparatus comprising:
a microphone having a detection range and being adapted to collect sound data from a sound source located within the detection range;
a communication module adapted to receive external data from at least one of the other apparatuses;
a control unit, operably connected to the microphone, to the communication module and to the given light source, for controlling the light intensity of the given light source, the control unit being adapted to:
   receive sound data from the microphone and external data from the communication module;
   compare the sound data and the external data to determine a location of the source; and
   if the sound source is determined to be closer to the apparatus than to any one of the other apparatuses, change the light intensity of the given light source to an operating mode.

Features and advantages of the subject matter hereof will become more apparent in light of the following detailed description of selected embodiments, as illustrated in the accompanying figures. As will be realized, the subject matter disclosed and claimed is capable of modifications in various respects, all without departing from the scope of the claims. Accordingly, the drawings and the description are to be regarded as illustrative in nature, and not as restrictive and the full scope of the subject matter is set forth in the claims.

### BRIEF DESCRIPTION OF THE DRAWINGS

The accompanying drawings, which are included to provide a further understanding of the invention are incorporated and constitute a part of this specification, illustrate an exemplary embodiment of the invention that together with the description serve to explain the principles of the invention.

FIG. 1 is a side view illustrating a light pole in a street environment, the light pole having a field of view and a field of illumination, according to an embodiment;

FIG. 2 is a top view illustrating the light pole of FIG. 1;

FIG. 3 is a top view illustrating a network of light poles, according to an embodiment;

FIG. 4 is a top view illustrating a network of light poles reacting to the passage of a pedestrian, according to an embodiment;

FIG. 5 is a top view illustrating two light poles reacting to the passage of a pedestrian, according to an embodiment;

FIG. 6 is a graph illustrating the light intensity of three light poles reacting to the passage of a pedestrian, according to an embodiment;

FIG. 7 is a picture illustrating the images taken from a camera, according to an embodiment;

FIG. 8 is a picture illustrating the image of FIG. 7 after corrections are applied, according to an embodiment;

FIG. 9 is a picture illustrating the image of FIG. 8 within a grid for image analysis, according to an embodiment;

FIG. 10 is a density map illustrating the detection of objects in pictures analyzed as in FIG. 9;

FIG. 11 is a flowchart illustrating the steps according to which a light apparatus becomes a master or a slave, according to an embodiment;

FIG. 12 is a block diagram a light apparatus, according to an embodiment;

FIG. 13 is a graph illustrating the waveform of detected sounds from a pedestrian; and

FIG. 14 is a flowchart of a method for controlling a light intensity of a given light source in a light network comprising other light sources, in accordance with an embodiment.

In the following description of the embodiments, references to accompanying drawings are by way of illustration of an example by which the invention may be practised. It will be understood that other embodiments may be made without departing from the scope of the invention disclosed.

### DETAILED DESCRIPTION

In a first embodiment (aka camera embodiment), there is disclosed a light apparatus that controls light poles and communicates information with other apparatuses even though no communication network is provided. In the first embodiment, there is a camera having a field of view (FOV) and adapted to acquire images of its FOV. A control unit is provided and receives the images from the camera and analyzes them to detect a movement in the FOV, or to detect that the light intensity of at least one neighboring light source undergoes a change according to a first pattern (i.e., the neighboring light source becomes a “master”). Upon detecting that a neighbor became a master, the given apparatus changes the light intensity of the given light source according to a second pattern, thereby becoming a “slave”. Otherwise, upon detecting a movement in the FOV, the given apparatus changes the light intensity of the given light source according to the first pattern, thereby becoming a master. The detectability and interpretability of the changes in light intensity of an apparatus by its neighbors allows non-hackable communication between the apparatus and its neighbors.

There is further described a second embodiment (aka blind embodiment), in which there is provided a microphone having a detection range and being adapted to collect sound data from a sound source located within the detection range, and a communication module adapted to receive external data from at least one of the other apparatuses. A control unit is provided and receives sound data from the microphone and external data from the communication module, and compares these data to determine a location of the source. If the sound source is determined to be closer to the apparatus than to any one of the other apparatuses, the control unit changes the light intensity of the given light source to an operating mode. The second embodiment will be described further below.

General considerations about the light apparatus will be described first, then the “camera embodiment”, and finally the “blind embodiment” of the light apparatus.

### General Considerations on the Light Apparatus

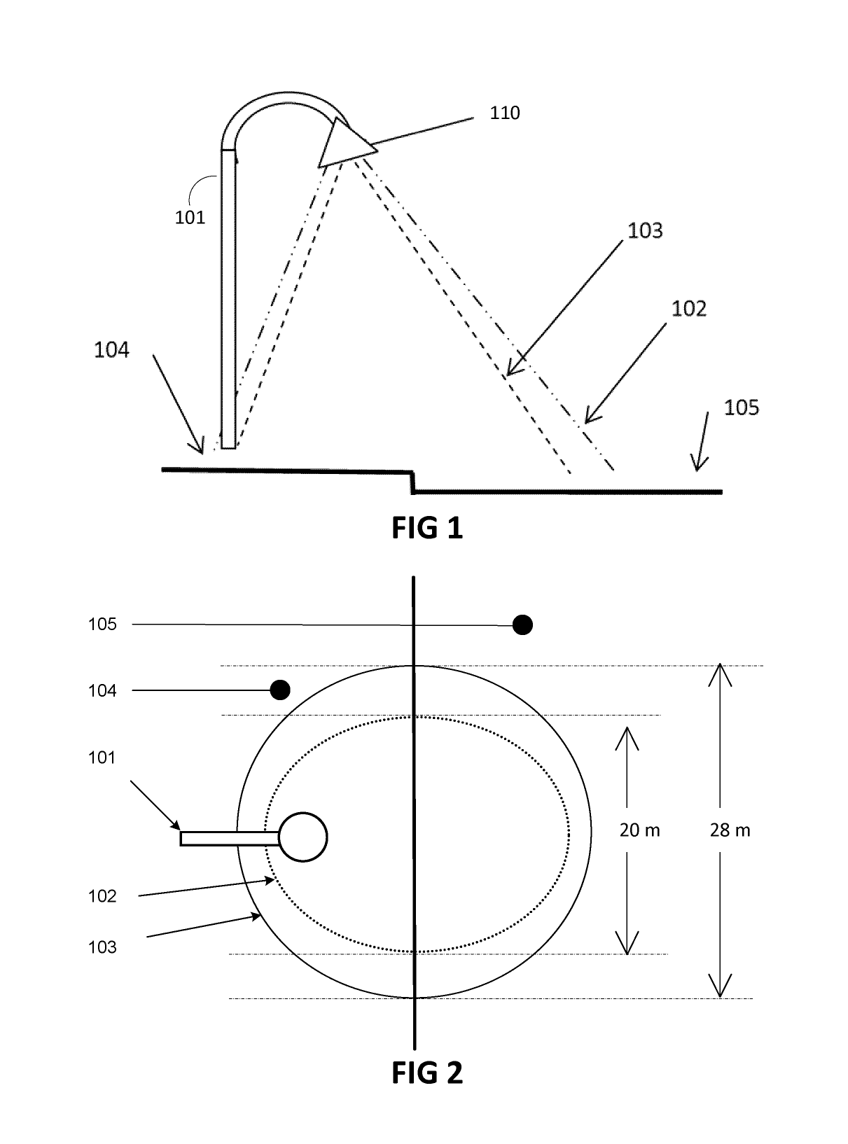

In FIG. 1, there is shown a light apparatus 100 mounted on or enclosed within a light pole 101, usually within the light fixture 110 (or elsewhere on the light pole 101 if needed). The light apparatus 100 should be installed high above the ground (usually some meters high) to illuminate the area defined as a field of illumination (FOI) located roughly under the light pole.

The light apparatus 100 can be defined in various ways depending on the embodiment (e.g., defined as including the light source or not, being part of the light pole or not, etc.). For the purpose of the present description, the light apparatus 100 will be formally defined as module that can be installed in the socket of the light fixture of the pole, the apparatus being separate from the light source(s), which can be manufactured and sold separately.

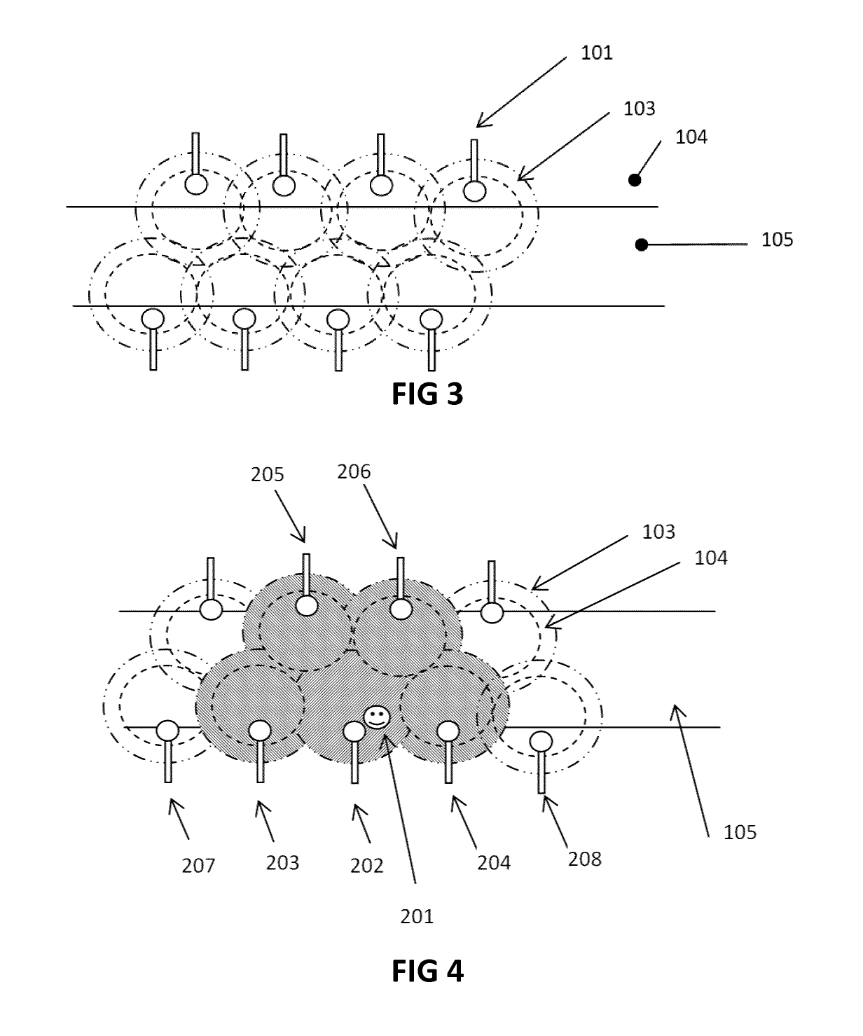

The light pole 101 can be installed virtually anywhere, but is in practice very often installed on the side of a road 105. Usually, if a sidewalk 104 is present, a light pole 101 illuminates both the sidewalk 104 and the road 105, as shown in FIGS. 1 and 2. Light apparatuses are provided in the form of a network (i.e., a plurality of nodes, where each node can communicate with at least another node) comprising a plurality of light apparatuses, as shown in FIG. 3. Light poles can be arranged in a spatial layout known in urban planning, for example: single side of a street, double side of a street (with or without a shift of half the distance between poles), or grouped on a single pole (as in a parking lot or on the median of a road). These layouts are given as examples; light apparatuses can be made to work in any layout or on light poles which are not arranged in specific layouts.

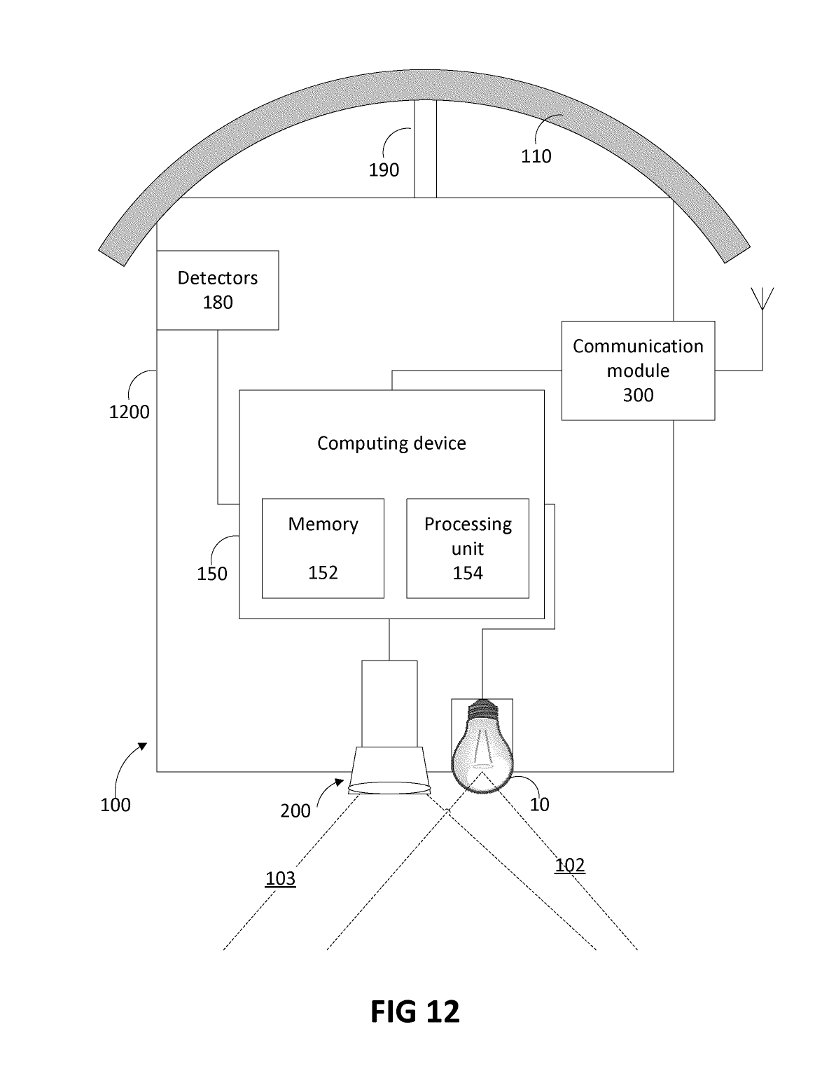

In FIG. 12, a light apparatus 100 comprises a camera 200 (unless otherwise noted) to take images, a computing device 150 operably connected to the camera 200 to receive data therefrom, to perform computer-executable instructions on the images, sensors 180 that are operably connected to the computing device 150, which can take decisions based on received data. According to an embodiment, the light apparatus 100 may also comprise a communication module 300 operably connected to the computing device 150 for inputting and outputting signals for communication. The capabilities of the communication module 300 will be detailed further below. In the blind embodiment, the camera 200 is replaced by a microphone 1000, in which case the communication module 300 is needed. Light source(s) 10 are provided, the apparatus 100 having an operable connection to the light source(s) 10 for control thereof. A power source 190 for the light apparatus 100 can be provided, usually from the power grid, but alternatively from a battery. The light apparatus may be advantageously installed within an enclosure 1200 for keeping parts together and facilitate rapid installation and handling by municipal staff.

The computing device 150 comprises a processing unit 154 to perform calculations and other logic operations based on computer-executable instructions which are stored on a memory 152. The results of the operations performed by the processing unit 154 can be stored on the memory 152. The memory 152 can comprise a plurality of memories dedicated to different uses of data. The processing unit 154 can comprise one processor or a plurality thereof. The computer device also comprises input/output connectors to connect peripherals thereto. For example, the camera 200, the light source 10 (or a dedicated power controller), the sensors 180 and the communication module 300 (if present) can all be connected to the I/O connectors of the computing device 150 to provide the operable connection between them. These operable connections between the computing device 150 and its peripherals are shown in FIG. 12. Accordingly, the computing device 150 can also be considered as a controller for the apparatus.

According to an embodiment, the light apparatus may comprise sensors 180 (aka detectors). The sensors 180 can comprise a compass, a vibration sensor, a level, weather-monitoring detectors, and other suitable detectors. The sensors 180 can also include a microphone (or a set of microphones), the use of which will be detailed further below in relation with the second embodiment.

As detailed further below, the camera is used to detect movement and the nature of movement, but also to analyze the lighting pattern in the FOI of neighbors. It also allows to analyze the dispersion of its own lighting in its own FOI.

As it will also be described in further detail below, microphones are used for sound recognition to detect conditions that should lead to lighting up the apparatus. The microphone embodiment (“blind embodiment”) may work without the camera sensors, removing some features, but allowing a cheaper manufacturing cost and less energy spent in computer vision processing of the images from the camera.

The other sensors like the compass and the vibration sensor are more aimed at helping installation and servicing/maintenance of the equipment. With the compass, the orientation of the apparatus can be determined, which is especially useful when the pole holds more than one apparatus. Many apparatuses can be provided on the same pole, as in a parking lot, in which case they are so close that they highly interfere in lighting analysis. In this case, taking into consideration the data from the compass allows some intelligent decision taking without requiring any specific setup at installation. The vibration sensors are used for servicing, allowing vibrations, produced by a local vibrating device, to be used by maintenance staff as a communication method with the apparatus. The vibration sensor can also detect other conditions like the hitting of the pole by a car or a tree branch.

Each light apparatus 100 is used to selectively power up its corresponding light source 10 (aka lamp), depending on the environment. If suitable movement is detected, the light apparatus powers up its light source 10 and stays at a high level for a given time. The light source 10 can be modulated in intensity by the light apparatus 100 to apply various intensity patterns that can be analyzed by neighboring light apparatuses, as explained further below in relation with the first embodiment.

According to an embodiment, the light source 10 which is operably connected to the light apparatus 100 comprises a LED or a plurality of LEDs which act as a unique light source. Other types of light sources, such as lightbulbs, can be used as long as the light power emitted therefrom can be controlled to provide the characteristic patterns in a reproducible fashion.

The camera embodiment uses the camera to analyze residual street light when in standby mode and to decide if it needs to turn on the light source 10 to a dimmed mode or can keep it off because enough light is provided from other sources.

The microphone embodiment (or blind embodiment) can turn off completely the light apparatus when in standby mode because no residual light is needed for sound detection.

A combined or hybrid embodiment made of a combination of the microphone and camera embodiments has the camera and microphone work such as a sound, even faint, is detected and used to turn the apparatus to a dimmed mode, wherein the computer vision processing allowed by the camera 200 can take place.

It must be noted that any mistake in detection of sound (like wind) or images (like strange objects) should benefit to the light-up condition to reduce hazards in the area of concern.

### First Embodiment

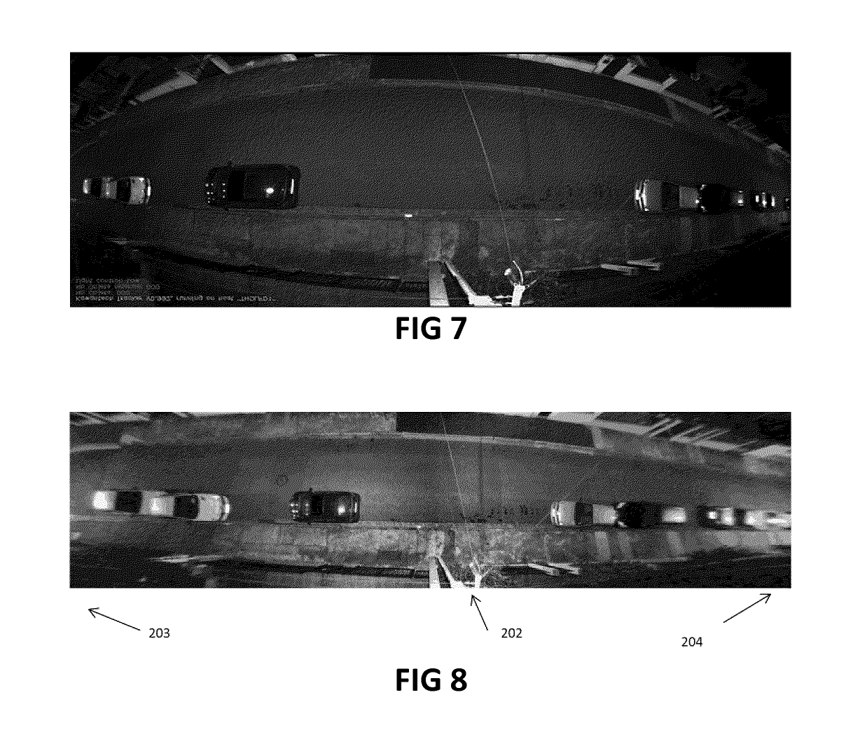

FIG. 12 shows the light system 100 installed on a portion of the light pole 101 such as the light fixture 110 of the pole. Each light apparatus 100 comprises an imaging device, such as a camera 200 that monitors an area around the light pole on which each light apparatus is installed. Each camera 200 has its own field of view (FOV) 103, i.e., the area that can be seen by the camera 200. For a given apparatus, the FOV is preferably slightly wider than the FOI in order to monitor the area of concern, such as a street as seen in FIG. 7, for example. According to an embodiment, a wide-angle lens is installed on the camera 200 to provide the desired FOV.

As can be seen in FIG. 2 (top view of the light pole 101), the FOI 103 is usually smaller than the FOV 102. Having a larger FOV 102 allows a given light apparatus to detect variations in the FOI 103 of its neighbors.

A neighbor, or neighboring light apparatus, of a given light apparatus 100 can be defined as any light apparatus that has a FOI 103 which intersect with the FOV 102 of the given light apparatus 100, or any light apparatus that has a FOV 102 which intersect with the FOI 103 of the given light apparatus 100 (both statements should give the same result since light apparatuses are normally identical).

This is shown in FIG. 4. A light apparatus 202 has the following neighbors: light apparatuses 203, 204, 205, 206, because the FOV 102 of light apparatuses 203, 204, 205, 206 all intersect (i.e., cover partly) the FOI 103 of the light apparatus 202.

If the FOI of the light source 10 of a given light pole has an area in common with the field of view of the camera 200 of another light pole, communication between the light apparatuses on these light poles becomes possible. The light source of the first light apparatus can be modulated according to a given pattern. If the camera 200 of the second light apparatus is able to detect the light emitted from the first light apparatus, and therefore detect the patterns encoded in the light signal, then information can be transmitted from the first light apparatus to the second light apparatus, as long as the apparatus can interpret the pattern as a piece of information. By expanding this model for a plurality of spatially dispersed light apparatuses, one can build a network of light apparatuses that can communicate with their direct neighbors using illumination patterns.

However, programming a light pole to get turned on automatically if a neighboring one is also turned would induce a “chain reaction” and the whole network will get turned on if a movement is perceived somewhere in the city. There should thus be a way to identify light poles with respect to their level of proximity with the object of which the movement was perceived to make sure that light apparatuses close to the object turn on their light source, while preventing further light apparatuses to do the same.

Therefore, at a given time, not all light apparatuses are “equal”. The light apparatus that detects movement of a given object in its FOV is defined as a “master” with respect to the given object. A light apparatus that is a direct neighbor of a “master” is defined as a “slave” with respect to the given object.

When becoming a master, the light apparatus will fully illuminate its field of illumination (FOI) by controlling its change in illuminating power following the “first pattern”. The light-up condition should extend to neighboring apparatuses even though they have not detected a condition to light up. The neighboring light apparatus (e.g., apparatus 204 in FIG. 4) will detect in its FOV the illumination of the FOI of the “master” (respectively apparatus 202 in FIG. 4) according to the first pattern and interpret this change as a signal to light up. Otherwise, apparatuses are in in standby mode, as in FIG. 3.

Otherwise, upon detecting that a light apparatus became a “master”, the neighbors of the “master” will turn on. However, they should not turn on according to the first pattern, because doing so would wrongfully inform other neighbors that they are masters. To avoid any misinterpretation of the intention of poles lighting up as a slave (203 or 204), the apparatuses implement a lighting protocol that allows neighbors to interpret the reason why a pole lit up. This is achieved by using a second lighting pattern for a slave, so that a neighbor of a slave will recognize the status (master or slave) of the pole that lit up.

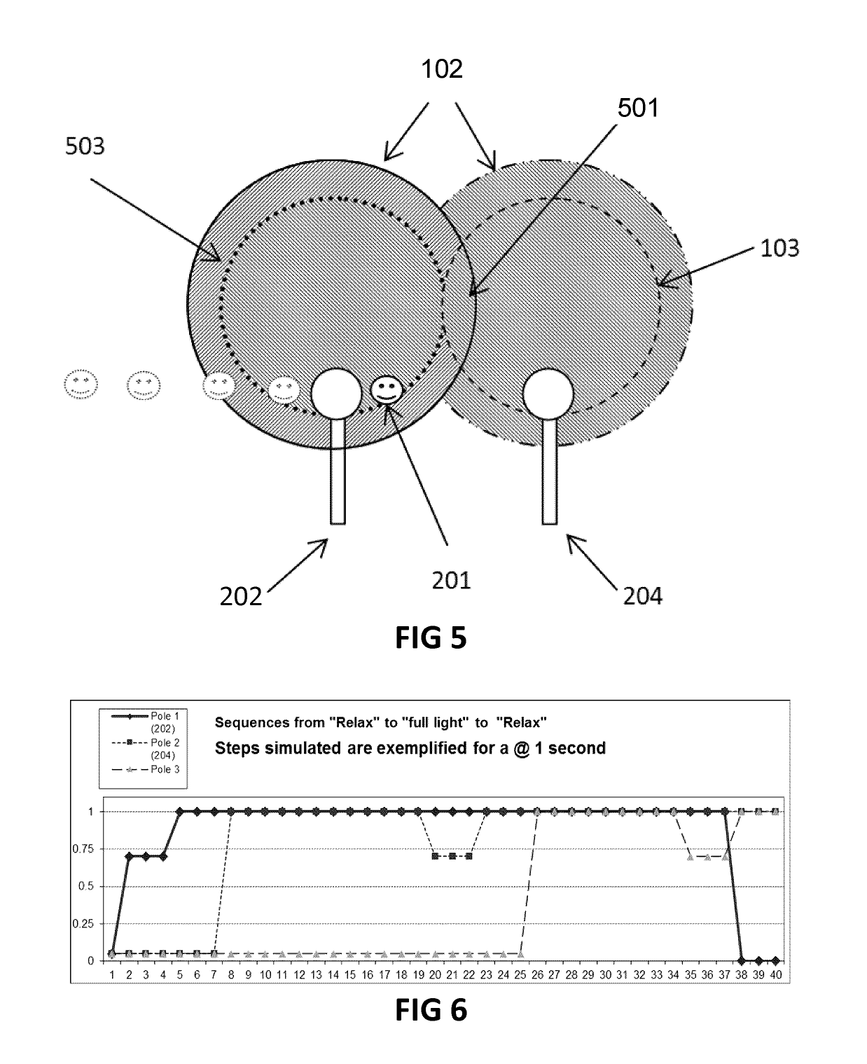

When the object 201 that triggered the master moves under the FOV of another pole, as in FIG. 5, where the object moves from under pole 202 to under pole 204, then the slave pole 204 detects the appearance of the object 201 and signals itself as a master, like 204 on FIG. 5. Since the pattern starts with an intensity which is different from that of a stand-by pole becoming a master, one may also interpret this pattern as a being a third pattern. It can be seen in FIG. 6, between time 19 and time 21, and will be explained further below.

Therefore, the neighbors of slaves which are not slaves (or master) themselves will not react and will stay in standby mode. (As the illumination patterns of a master and a slave are different, the principle can be extended if another embodiment is needed. For example, neighbors of a slave can be allowed to transition from a completely off condition to a dimmed light condition to enhance quality of any detection, decreasing the risk of missing an object having a movement hard to detect, like an extremely slow movement of a car or a door.)

The simplest manner in which a pattern can be implemented is the direct transition of the light source from its base mode (or other similar terms such as base state, initial state, default state, etc.) to its normal operating mode. The normal operating mode is the intensity emitted by a light pole when it is on and fully operating as a light pole.

For example, if the light source is off by default, its base mode is 0% of its maximum intensity. If residual light intensity is needed and not supplied (by natural street extraneous lighting such as moonlight, electric signage, or car headlights), the base mode is set at an intensity which is a small fraction of the maximum intensity (e.g., 5%). If the normal operating state of the light source is the maximum intensity, then it is set at 100% (or other arbitrary value). The pattern could therefore involve a direct transition from 0% to 100%. According to an embodiment, the second pattern, according to which a light apparatus 100 becomes a slave, is the direct transition from 0% to 100%, or from 10% to 90%. The fact that this transition is direct is the pattern that neighbors are looking for.

Another type of pattern can involve a transition from a base intensity to an intermediate intensity and then to the operational intensity. For example, the intensity of the light source can be controlled by its light apparatus to transition from its base mode which can be a dimmed mode (e.g., 5-10%) to an intermediate mode (e.g., 70%), make a pause of a few hundreds of milliseconds, and then transition to the normal operating mode (e.g., 100%). If the light apparatus 100 was already a slave, the pattern can be 100% (initial state) to 70% (intermediate step with a pause) and back to 100%. An intermediate value higher than the operating intensity is also possible (e.g., 0% to 100% to 80%). The only requirement is that the intermediate level is distinct enough (in intensity) from the base level or operating level to be differentiated by the camera 200 of the neighboring light apparatuses, and that the intermediate level is kept during a sufficient period of time to be detected by the camera 200 (preferably a few hundreds of milliseconds, e.g., 500 ms). According to an embodiment, the first pattern, according to which a light apparatus becomes a master, is of this type. The FOV 102 sees a rather wide area of the FOI of neighbors, as shown in FIG. 8, where the FOI of poles 203 and 204 cover a large area on the ground seen by the camera 200. This implicitly reinforces the system against intentional or non-intentional reading by the camera 200 of a lighting pattern done outside of the proper operation area.

Of course, the first pattern and second pattern can be interchanged, as the meaning of these patterns is only a matter of convention implemented within the network. For example, how patterns should be interpreted can be stored on the memory 152 and compared with the measured signals by the processing unit 154 of the computing device 150 to make a determination about the state (master, slave) of the illuminating neighbors.

Other types of patterns may be contemplated. For example, a pattern can be characterized by a rise time. For example, a first pattern can be characterized by a rise time of 300 ms required to go from a base level to an operating level, while the second pattern would be characterized by a rise time of 600 ms required to go from a base level to an operating level (time values are only indicative).

Various combinations of rise times and multiple intermediate levels can also be contemplated.

Patterns are preferably based on relative levels of intensity and optionally on the time to reach these relative levels. This allows addressing the effect of environmental condition, like weather conditions, on the intensity of a light source as measured by the cameras 200 of the neighboring light apparatuses. For example, the presence of fog, rain, snow, spider webs, etc., will usually decrease the perceived intensity by neighboring cameras 200 compared to a normal situation. The presence of puddles on the road or parked vehicles may increase reflection and increase the perceived intensity by neighboring cameras 200. Intensity changes are less perceivable at twilight or dawn when the overall luminosity is higher than in the middle of the night, and they are also less perceivable if nearby stores display luminous commercial signage or if people manipulate strong light sources from the ground. Providing patterns which rely on intermediate levels (kept for a given duration), rise times and the like give a temporal profile to the intensity transition that is independent of the environmental conditions and can thus be discriminated unambiguously regardless of the weather or other environmental considerations.

It should be noted that the rise time for the illumination of a light source 10 (from 0% to 100% light intensity without any other type of control or pattern) can be in the order of 100 ms. The patterns should be designed with consideration to this natural rise time. For example, a pause of 500 ms at an intermediate level (or a controlled rise time of 500 ms) is normally unambiguously discernable from the 100 ms rise time that is present by default. Consideration should also be given to the frame rate of the CCD array of the camera 200, usually between 20 and 60 frames/second (if not using a specialized sensor or a modified CCD reading pattern). A number of frames may be needed to capture the pattern of a master, as seen in FIG. 6. This should be accounted for in the determination of a pause time for first pattern.

In FIG. 6, there are shown time series of the activity (light intensity) of three light poles. Light pole #1 is neighbor with light pole #2. Light pole #2 is also neighbor with pole #3. Light poles #1, #2 and #3 can thus be interpreted as light poles 202, 204 and 208 in FIG. 4, respectively. FIG. 5 further provides a close-up view on light poles 202 and 204, where the movement of a pedestrian into the FOV of light pole 202 is also apparent.

In FIG. 6, at Time 0, there is no action in the FOV of the light poles. At time 1, movement of an object is detected in the FOV of light pole #1. The light pole #1 thus becomes a master and starts illuminating according to the first pattern. It means that the intensity of the light pole #1 rises up to an intermediate value (70% in this example) and pauses during a given amount of time (shown as 2 time increments in the example) before rising up at 100%.

From the moment light pole #1 makes its transition from 70% to 100% at time 5, its neighbor, light pole #2, can unambiguously determine that light pole #1 just became a master. Of course, in practice, some time dedicated to the analysis of the pattern sequence is needed by the device to make this determination (the processing time is 2 time increments in the example). Therefore, light pole #2 can become a slave and starts illuminating according to the second pattern (in the example, the second pattern is a “direct” transition from 5% to 100%, where direct is intended to mean “as fast as possible” as explained above with respect to natural rise times). At time 8, it is still impossible for light pole #3 (neighbor to light pole #2) to determine if light pole #2 is a master or a slave. From about time 10, it is clear that the light pole #2 did not raise its intensity a second time as expected in a first pattern. Therefore, from time 10, light pole #3 can determine that light pole #2 started illuminating according to the second pattern and will not react (stay at the base mode with about 5% intensity).

At time 19, the object which was in the FOV of light pole #1 moves into the FOV of light pole #2, which detects the movement. At this moment, light pole #2 becomes a master and needs to notify this change of status to other light poles. The way to signal the status change is not different from what happened previously with light pole #1; the light intensity will reach an intermediate level (70% in this example), make a pause at the intermediate level (during two time increments in this example), and then reach the maximum intensity (100%). The only difference with the previous light pole is that the intensity of a slave becoming a master goes down to the intermediate intensity because it was already at a maximum intensity.

From time 23, the neighbors of light pole #2, i.e., light poles #1 and #3, will be able to determine that light pole #2 became a master because the whole pattern of transiting to an intermediate intensity and then to the maximum intensity has been observed. Light pole #1 will thus stay at maximum intensity (it was already there because it was a master before) and light pole #3 will reach the maximum intensity according to the second pattern (i.e., directly in this example).

A similar process occurs from time 35, where the light pole #3 detects movement in its FOV and becomes a master. It exhibits the first pattern and returns to the maximum intensity at the end of the first pattern. At the same time, light pole #2 stops being a master and becomes a slave as did light pole #1 at time 19.

According to another embodiment, light pole #1 did not become a slave at time 23-25. Instead, light pole #1 knows it loses its master status by time 19 (when the object moves to the FOV of light pole #2), but remembers its master status during a given period of time. In the example shown in FIG. 6, light pole #1 remembers its master status during 20 time increments after the effective end of its master status (the last movement detected by light pole #1 was at time 18). It is why the light pole #1 shuts down (to the base mode) at time 38.

FIG. 7 is an example of a picture taken by a camera 200 and sent to the computing device 150 for correction and analysis. Since the picture is taken from a wide-angle camera, distortion of the picture is very apparent. The closest objects appear larger on the picture than the most distant objects. Moreover, light intensity on the picture is greater on closest objects than on the most distant ones. Since the peripheral regions of the picture need to be constantly monitored for intensity changes, it is preferable if corrections are applied.

The corrections that can be applied include barrel distortion and histogram neutralization. Indeed, due to the point of view of the camera 200, straight lines appear curved as exemplified by the contour of the road in FIG. 7, which is strongly curved. After the correction is applied, the curve, which is due to optical distortion and which is not present in reality, is removed from the picture and the road appears mostly straight in FIG. 8.

The histogram neutralization is useful in correcting the light intensity from areas which are more distant from the cameras 200. Distant areas appear darker in FIG. 7; their intensity increases in FIG. 8 after neutralization. Close to the periphery of the pictures, a portion of the FOI of the neighbors (203, 204) is seen in FIG. 7, but is better distinguished in FIG. 8.

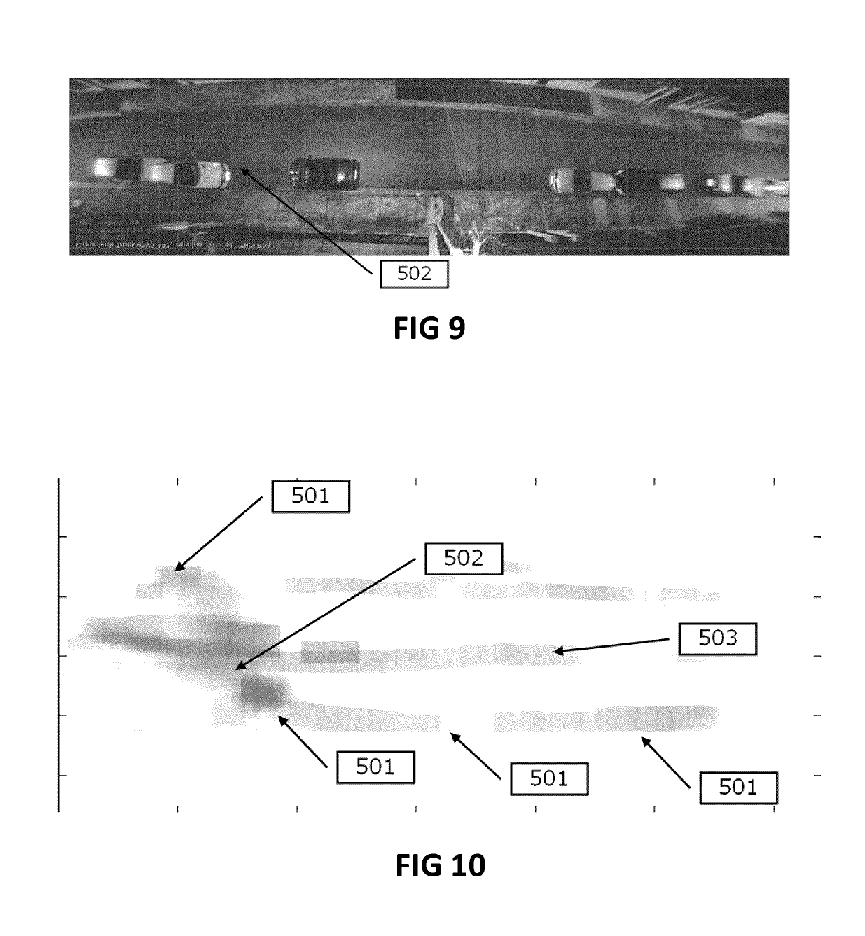

The picture (preferably the corrected one) is then analyzed. According to an embodiment, the analysis relies on a grid system, as shown in FIG. 9. In FIG. 9 (as in FIGS. 7-8), the light pole 202 illuminates with an operational intensity. If the light pole 202 was illuminating in its base mode, the intensity would be lower (it would be minimal). According to an embodiment, the minimal amount of light to emit is determined based on the darkest cell on the grid, since movement should be detectable in each cell on the grid.

The grid is used to quantify the light intensity in each cell. For the cell at both ends of the picture, a change in measured light intensity can be monitored. When a change occurs, the time series of the light intensity in one cell or in a few cells can be analyzed to identify a pattern in the change, i.e., a first pattern or a second pattern. If the first pattern is identified, it means that the neighbor (203, 204) became a master and the light pole 202 will become a slave and illuminate (starting the illumination according to the second pattern). Alternatively, if the second pattern is identified, it means that the neighbor (203, 204) became a slave and the light pole 202 will not react (unless multiple-level slaves are used, as briefly mentioned above).

Outside of the regions which belong to the FOI of the neighbors (203, 204) most of the cells of the grid “belong” to the light pole 202. A change in a cell can be interpreted as movement. Various algorithms for movement detection or object detection/identification can be implemented, from very simple algorithms (where a change in a cell is interpreted as a movement) to more sophisticated algorithms (direction identification, car/pedestrian recognition, animal recognition, etc.). In these cases, unless specific conditions are determined (e.g., the object is identified as an animal), the light pole 202 will light up according to the first pattern and thereby become a master. It should be noted that becoming a master should override the slave state. Therefore, a light pole in a slave state that detects new movement in its FOV (e.g., person going out from a building) should become a master so that its neighbors can react accordingly.

FIG. 10 is a density map built from pictures as the one of FIG. 9 taken repeatedly (i.e., a film) over a given period. In other words, density maps for a given picture are accumulated over time to give FIG. 10.

Movements can be analyzed as shown in FIG. 10. Since the movement of an object in space is continuous, moving objects can be tracked. For example, pedestrians are small and slow compared to vehicles, which are bulky and usually faster than pedestrians. FIG. 10 identifies a vehicle 503 which moves along the road. A pedestrian 501 is also distinguishable. It can even be seen crossing the street at point 502.

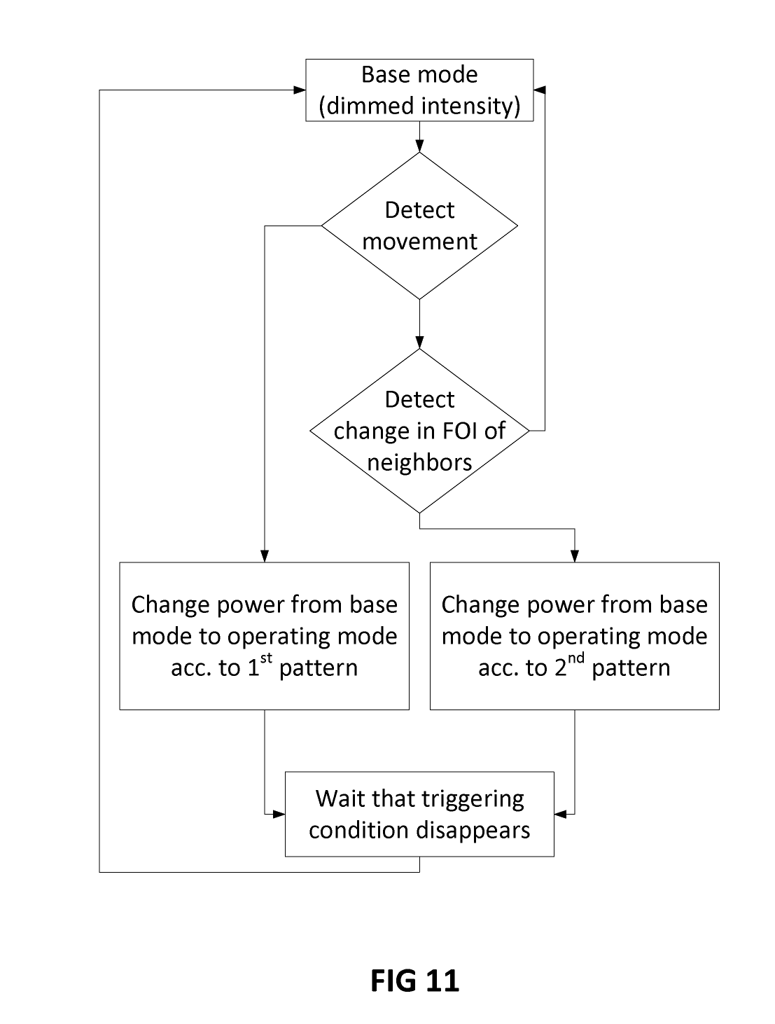

FIG. 11 summarizes the flowchart of actions performed by a light pole regarding the transition to the “master” state. At first, the light pole is in its base mode (dimmed intensity). As long as nothing happens in the FOV, no action is performed; the light pole keeps monitoring the FOV for changes (movement or neighbor becoming a master). If changes are detected, a determination must be made. If the change involves a neighbor lighting up according to the first pattern, it means that a neighbor became a master. The light pole will thus start illuminating according to the second pattern. In this example, the second pattern is the direct transition from the base mode to the maximum intensity (100%). If movement is directed in the FOV, the light pole becomes a master and will thus start illuminating according to the first pattern. According to an embodiment, the light pole will go back to an initial state (i.e., base mode) when the condition which triggered the illumination is no more present (either the master neighbor shuts down, either movement is no more detected). Direct transition from master to slave or slave to master without temporarily returning back to base mode may also take place.

According to an embodiment, the light source 10 on the light pole 101 comprises a plurality of individual light source elements which can be controlled individually or in small groups. According to that embodiment, each of the individually controllable light source elements can be dedicated to a specific lighting zone. In this case, the FOI of a given light apparatus 100 is a set of sub-zones which can be handled individually by the light apparatus 100. The behavior of a specific light source element with regard to its dedicated sub-zone can be independent from the behavior of a neighboring light source element in the same light pole with regard to its own dedicated sub-zone. A practical way of implementing this embodiment would be to detect the location and nature of the object moving in the FOV. For example, if a pedestrian walks on the sidewalk or if a car moves on the road, different sub-zones within the whole FOI are involved. Light source elements which are directed toward the object (toward the sidewalk or toward the road, in this example) could be triggered independently if they are needed. This embodiment is advantageously more flexible or adaptive since it provides more localized illumination toward specific areas on the ground only where lighting is needed.

Accordingly, if each light source element is dedicated to a specific lighting sub-zone, each of the light source elements can be provided with a lens that focuses light on the specific lighting sub-zone. According to an embodiment, the light apparatus 100 is designed in such a manner that the grid shown in FIG. 9 matches sub-zones to which each light source element is dedicated.

According to an embodiment, the patterns (first pattern, second pattern, etc.) can be detected in only one cell or a few cells in the grid of the FOV. If a plurality of light source elements are provided, only the ones which are necessary will be lit up (i.e., will emit light as a slave). Also, the plurality of light source elements can be lit with regard to preferential directions in the environment, most notably the street. For example, a light pole 101 located at the side of a street may light up all its light sources which are directed along the direction of the sidewalk while keeping off the light sources which are directed to the street, assuming that the newly detected object (e.g., pedestrian) will continue on the same sidewalk in the same direction without changing trajectory. Doing so means that the next light pole along the sidewalk will be notified of a probable future movement and will thus become a slave. However, a light pole at the other side of the same street, which would normally have detected the luminosity of the light pole which is currently a master, will not detect anything because of the selective nature of the illumination by the master light pole (it does not illuminate the street, which is where the intersection between the FOI of the master and the FOV of the other light pole occurs). Probably useless illumination is thus prevented and some power is saved. If the pedestrian changes its trajectory, the master light pole is able to detect the insufficiency of its selective illumination and light up all relevant light sources which are under its direct control, thereby notifying the facing light pole on the other side of the street that it is a master.

According to an embodiment, instead of a camera, an array of light sensors (aka beam detectors) directed (and focused) to a specific area on the ground is used for pattern detection. There are no image recognition capabilities but a light apparatus comprising such a vision system can still work as a slave. Basic movement detection can be implemented using these narrow beam detectors, as done in lift surveillance systems which use infrared. Two modes of operation exist for this embodiment, depending upon the capabilities of the light source. In an embodiment, many sensors target different grid areas. In another embodiment, the light source is made of an LED array and the sensors can be a single wide-angle detector. In this case, the LED's distinct short light burst which follows a pattern allows getting information selectively for each part of the FOI.

It should be understood that all embodiments described above prevent all sorts of hacking because no communication network is provided even though light poles communicate together. The absence of a communication network simply impedes hacking.

According to another embodiment in which high but not necessarily impenetrable security is needed, it is possible to provide a communication module 300 using a communication network for informational purposes (i.e., to gather and share information). This embodiment does not connect the operative functions of light apparatuses to any communication network, which means the lighting systems cannot be hacked. A radio transceiver can be used to transmit and receive information to and from other light apparatuses, or to and from a head station or remote server. Information sharing can be used to gather data for statistics, to inform light poles of special events requiring increased lighting, to determine failure or damage of light apparatuses or for better decision-taking. According to an embodiment, the information can be used to monitor parking spaces or determine if the prohibition to park somewhere is violated. The geographical contour of the space being monitored can be defined as a pixel contour in the frames taken by the camera 200. Spaces may also be correlated to parking space numbers, allowing authorities to be made aware of the presence of a car and the date/time when this occurred, optionally saving pictures as dated proof of the illegal parking.

If information is sent from a light pole to a remote server, the remote server may be able to diagnose problems with the light pole, such as a disorientation of the light apparatus determined by the camera 200 or sensors 180.

According to an embodiment, each light apparatus which transmits data to other light apparatuses and/or to the remote server is associated to a geographic location, either based on the “address” of the light apparatus (i.e., its ID, serial number, etc.) which is associated in a database to a location, either by providing a GPS device or an equivalent thereof (usually based on triangulation) in the light apparatus (which can then be used to make the association between a given light apparatus and a location, or for stamping the transmitted information with geolocation data).

Data transmission can be made through a radio network. According to an embodiment, the network uses short message service (SMS) technical realization (GSM). (GSM devices can also be used for basic sound detection, and sound detection will be described in detail further below.) According to an embodiment, most light apparatuses can only transmit to and/or receive from other light apparatuses; while some of them are specifically adapted to transmit/receive via a communication network to the remote server.

According to an embodiment in which a communication network is provided for information sharing, data collected from the cameras 200 of two neighboring light apparatuses can be used to provide a multiscopic vision of the environment. Image processing (from at least two different cameras) allows the determination of the height of the object(s) in the environment. This is possible if the time stamp on each frame of the video from all cameras 200 is exact, since the time at which the image was captured is used in the algorithm of height calculation (the required precision on the time stamp depends on the target precision on calculated height). A universal time reference (e.g., atomic time reference communicated by a radio network) can be used to avoid asynchronism between cameras 200 which could lead to erroneous calculations.

An intuitive example of how height can be determined is to consider an elongated object, such as a human walking in a standing position. A person walking far from the camera 200 will appear as an elongated object. The same person passing under the camera 200 will appear less elongated and more circular (only the top of the head and shoulders are seen). The change in cross-section is thus characteristic of a human. A dog which would walk on the same path has its body close to the ground and will thus appear with a similar cross-section the whole time. Objects which have a size determined as under a given threshold may be considered as animals and therefore not trigger anything in the light apparatus. It may trigger illumination up to an intermediate level only in case the determination is uncertain. The determination can also be transmitted to neighboring light poles.

According to an embodiment, in order to limit the bandwidth of transmitted data between light apparatuses, only key information is transmitted, for example, only some features of images may be transmitted, and only if movement was detected in these images. For example, if 4 features have been identified in the picture, and if each feature is characterized by a small amount of bits (e.g., 12 bits), the required bandwidth is reasonable. Doing this does not create a 3D representation of the environment but is rather used as a fast determination of the size of the object moving in the FOV.

Size or height determination of an object can be used to discriminate the nature of the object that was detected.

In the embodiments described above comprising modules for communicating over a network, safety is not compromised, because the communication network is mostly used for informational purposes and not for main operational purposes. If hackers penetrate into the system, they can steal information or prevent its transmission, which is not critical for safety or comfort. This apparatus is designed to be intrinsically safe against hacking that would be aimed at switching off light permanently, a situation that could allow people to hide or stand unseen in the street. No communication can turn off the lights, and the size of the area that needs to be covered by the FOV for control is large, thereby increasing safety of the system. Since information sharing is usually required to identify animals, the worst that can happen if the network is hacked is that light apparatuses will fail to determine the height of objects like animals and will thus light up for dogs, cats and squirrels.

If, for some reason, sensitive information needs to be communicated to a light pole, this may be performed via a dedicated device used by maintenance teams on the field who can transmit, for example, optical signals directly into the light apparatus, or using a light projection on the ground (in the FOV of the light apparatus) that is detectable and interpretable by the light apparatus 100. This optical or light signal can involve a specific servicing pattern that can be interpreted by the light apparatus 100. Field presence in a wide area of the FOV and dedicated equipment are required; so hacking is less likely to occur. The light apparatus can be made to inform the remote server via the communication network that it is currently receiving information from a local device, thereby cross-checking the legitimacy of data input.

According to an embodiment, the light apparatuses can receive information via the communication network. However, it is preferable if this information is not critical for triggering the illumination of light poles. For example, a signal sent from the remote server to the light apparatuses may inform them that an event takes place in a nearby location. The signal may be indicative of a higher probability of human presence and the light apparatuses will thus adjust the detection threshold to be more sensitive, or increase the duration of lighting. In this case, the information received would help in reducing the number of false negatives.

According to another embodiment, the communication network allows complete two-way communication. This is doable if safety of the light network is not an issue. In this case, the remote server may be used to help in detection, identification, determination of the nature of objects, etc.

### Second Embodiment

Now turning to another embodiment, there is described a light apparatus 100 that selectively turns light on and off based on surrounding sounds that are detected and analyzed.

In this second embodiment, the video capabilities permitted by the camera 200 can be shut down or even absent from the light apparatus. Therefore, a microphone 1000 is provided in addition to, or in replacement of, the camera 200. When the camera 200 is shut down or absent, the light apparatus is said to be in “blind” mode.

The microphone 1000 uses a chipset as those found in telephones or other telecommunication devices. In practice, the microphone 1000 can comprise two microphones or more that cooperate to cancel ambient noise and/or work in stereo to help localizing the target. The microphone 1000 “listens” to the surrounding sounds in hope of detecting a sound from a vehicle engine or a sound from a walking pedestrian, each one of the microphones being dedicated to one of the sound sources. Dedicating a microphone to one of the sound sources can provide advantages because the sounds emitted by pedestrians and car engines have different spectral distribution, and different frequency filters can be provided on each microphone to perform the discrimination between sound source types in a simple fashion.

Using microphones 1000 and analyzing the sounds measured by them is requires very low energy consumption to have the CPU analyze the signals. The low amount of measured data that is exchanged with other fixtures requires only a low rate of transmission and means that wireless communication can be accomplished in an effective manner.

It will be understood that an embodiment comprising microphones 1000 implies that a communication module 300 between light apparatuses needs to be provided. The light apparatuses cooperate, i.e., they share their collected data in order to take decisions. A communication module 300 based on radio signals can be a proper way to communicate between light apparatuses.

The sounds received by the microphones 1000 are characterized by an occurrence in time and by a spectral distribution, for example, that of a foot hitting the ground periodically. Microphones 1000 installed on distinct but neighboring light apparatuses 100 will be able to detect this sound. They will detect substantially the same spectral distribution for the same event, but the time at which the sound will be detected will generally differ since the microphones 1000 of distinct light apparatuses 100 are not equally distant from the source of the sound.

For example, a walking pedestrian will emit sounds which exhibit a power peak at a frequency in the range of 3,000 Hz (for normal footwear) to as high as 10,000 Hz (for high heels, a shock that produces noise as a formant over a white noise going up to 10,000 Hz, allowing a better discrimination of this short but characteristic event), for a duration of about a few milliseconds. The frequency spectrum around the peak is substantially dispersed along a 1/X² kind of slope. The presence of a specific spectral pattern may thus be looked up in the detected sound signals to determine that a foot step occurred. The moment at which this pattern is present in the signal detected by the microphone will be shared with other light apparatuses so that the location where the foot step occurred can be determined.

The use of a microphone 1000 in replacement of, or in addition to, a camera 200 is justified by the fact that there is a high correlation between noise detected in the street and the need to illuminate the street. A very quiet street, in which the question of whether or not a light pole should illuminate, is a situation in which noise can be easily detected and analyzed.

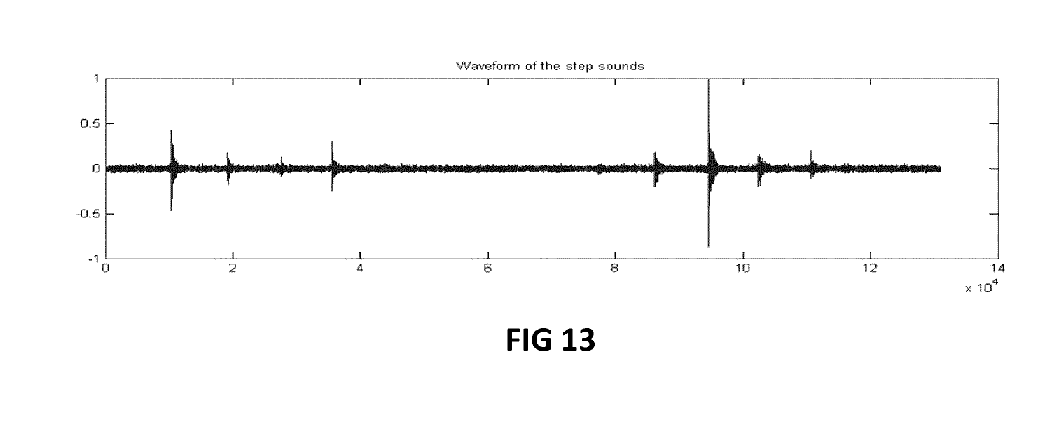

FIG. 13 shows a waveform of such noise, as seen in the article “Moving Humans Detection Based on Multi-modal sensor fusion”. The article “Vehicle Sound Signature Recognition by Frequency Vector Principal Component Analysis” presented at IEEE Instrumentation and Measurement Technology Conference, St. Paul, Minn., USA, May 18-20, 1998, shows that even cars and trucks can be discriminated in a fair way using noise. The interesting duration of the event is in the 3 ms range.

When a car generates noise, the engine works at about 1,000-6,000 RPM. Filtering frequencies from 10 Hz to 100 Hz and measuring the amplitude of the measured signal in this bandwidth can give sufficient information to determine the presence of a car. Filtering can be made using spectral filters, or one may decide to rely on natural frequency filtering occurring in the materials used in the light pole and light apparatus. Electric cars have a different frequency spectrum that may be hard to detect in the presence of other cars, in which case the mere presence of other cars will trigger the illumination of the light pole. If no other car is present, the noise of the electric car should be detectable and can be used to trigger illumination.

Providing a plurality of microphones 1000 on a plurality of neighboring light poles is interesting in that it provides a way to map permanent noise sources. In other words, background noise will be detected in a more or less constant fashion between neighboring light apparatuses, while walk steps of a pedestrians will be much stronger for the closest light apparatus where a microphone 1000 is installed.

According to an embodiment, a microphone 1000 is provided on the enclosure 1200 of the light apparatus 100. The bulky construction and mass of the light apparatus (which is for example in the order of 15 kg) may help in absorbing background noise before its detection by the microphone 1000. According to another embodiment, the enclosure 1200 of the light apparatus 100 is made of a non-dampening material such as aluminum, where the enclosure 1200 acts as a membrane for the microphone 1000 (the enclosure 1200 is exposed to the sounds and will mechanically react accordingly). The vibration analyzer (the part that creates an electric signal from the mechanical vibration) is thus directly coupled to the enclosure 1200 to form a microphone that works as a vibration sensor.

Using the communication network, collected sound data can be shared to determine the location of the sound sources and determine if they are moving. According to an embodiment, the location of the sound sources is continuously monitored to determine the direction of the movement of the sources.

The detection time of a sound by each microphone can be shared with the microphones of other light apparatuses to establish time differences. The comparison between sound data collected by the microphone 1000 of a given apparatus 100 and the external data collected from other apparatuses in communication with the given apparatus is performed to determine the location of the sound source. Indeed, using time differences and knowing sound speed in air, one may determine the location at which the sound was produced (e.g., a foot step, a car door being closed, etc.). The apparatus can thus change the intensity of the light source if the apparatus determines that it is the closest one to the sound source. According to an embodiment, it can also change the intensity of its light source if it determines that it is the neighbor to the closest one to the sound source. In the “blind embodiment”, a neighbor is not defined by the intersections of FOVs with FOIs; it is rather defined by physical proximity.

For example, if light poles are 15 m high and spaced apart by 30 m, the smallest time of flight for soundwaves is 15 m/sound speed i.e., in the 50 ms range. The longest detectable time of flight is 33 m/sound speed, which is in the 100 ms range. A one-millisecond accuracy for the clock (time source in the light apparatus) is enough to be used as a reference. It is thus possible to have an algorithm triangulate the sound source position within a 10% uncertainty level. This is sufficient for making a decision. It also implies that the light apparatuses 100 must know either their absolute geolocation, either the relative location with their neighbors.

According to an embodiment, the light apparatus 100 can be made aware, either by embarked detectors, either by reception of relevant data from the communication network, of weather data that may affect sound propagation.

According to an embodiment, the microphone 1000 acts as a vibration sensor that is sensitive enough in very low frequencies (2 Hz to 10 Hz) to monitor sound signals transmitted from the pole itself. This can be useful if a local communication device is to be used.

Maintenance work may imply that some data will be inputted into the light apparatuses. Sound detection means that data can be transmitted via vibrations. A local communication device for use by maintenance staff can rely on the generation of vibrations to communicate directly with the microphone 1000 of a light apparatus 100, for example by generating vibrations on the pole. The vibrations will then be detected and interpreted at the light apparatus 100 level. Data that is transmitted can be encoded in a format as specified by Manchester coding, with the help of a code-correction algorithm like Reed-Solomon to correct for defects. The purpose of such low frequency transmission is not a high volume of data but rather a time-limited cryptographic key used to decipher signals emitted by other sources as explained more extensively below. According to an embodiment, the vibration is not applied through the pole but directly on the light apparatus, thereby requiring an arm to reach the light apparatus. Vibrations can be produced by various means, such as an electromagnetic actuator. Data can thus be communicated from the operator present in the field to the light apparatuses in a secure manner. The need to be present in the field and the use of specific vibration-generating equipment can be considered as a substantial deterrent for hacking.

According to an embodiment, the goal of this procedure is not to transmit data (such as instructions, software updates and the like) but only to provide a key needed for security purposes. For example, data transfers, software updates and other data-intensive communications may be performed between a remote server and a light apparatus only if the key is provided. Having an operator mechanically provide the key mitigates the risk of hacking even though the light apparatuses are connected to a communication network. If a hacker tries to access or modify data in a light apparatus, the absence of the required key will impede him to perform damaging actions on municipal infrastructures, unless the hacker also uses the vibration-generating equipment in the streets, which is unlikely given the peculiar nature of the energy needed to generate the vibration. The data size of the key can be in the 256-Byte range. The data transmission process may require a few seconds and may further require that the key transmission by the vibration-generating equipment stays on during the whole update performed through an alternative high-speed data channel like the GSM onboard equipment.

The light apparatuses may also be directly accessible from the communication network if safety if not a priority, although security breaches are more likely to happen. Secure communication networks may be use to lessen risks of hacking.

Since movement detection can be video-based or sound-based, the apparatus description may be formalized as comprising a first detector and a second detector operably connected to the computing device 150, the first detector having a field of view (FOV), the second detector having a detection range. The first detector, detects a change, according to a first pattern, in a light intensity of at least one of the neighboring light sources (it detects that a neighbor becomes a master). The second detector detects a movement within the detection range. According to an embodiment (video only), the first detector and the second detector are the same detector, which is camera 200, in which case the detection range is to be interpreted as the FOV of the camera. According to another embodiment (hybrid), the first detector is camera 200 and the second detector is the microphone, which has its own detection range which may differ from the FOV of the corresponding camera 200 in the apparatus, although they may be of a similar range. According to another embodiment (sound only), the second detector is the microphone and the first detector comprises the computing device 150 in combination with the communication module 300, that together act as a detector for determining the state of the environment (i.e., location of the moving object, which neighbors are lit up, etc.).

The video-based embodiment as well as the blind embodiment would benefit from being automatically geolocalized in real-time. Radio echoes on building may however reduce the precision of geolocation, for example if a GSM module is used to determine relative positions between light apparatuses. The light apparatus, when installed for the first time, can be pre-loaded (in the non-transitory memory of the light apparatus 100) with a potential position or with a map of potential positions, and the final position value can be determined by finding which exact position better match geolocation and compass information. Knowing the exact location of each light apparatus 100 (or equivalently each light pole) can be used to associate the light pole with other parameters associated with the electric network to which the light pole is electrically connected, for example. Uploading a complete city map of light poles is well within the possibility even though memory size is limited. For example, the city of Boston has 67,000 light poles which require 16B of memory for geolocation. Together, they amount to about 1 GB of data in total, which is easy to handle by today's standards. Even though GPS information (or the like) is not precise, at least the location can be determined as the closest one in the list of precise locations stored in the preset data set. Optionally, the apparatus can use its camera 200 to monitor usage of parking lots or forbidden space. In this case, a set of geometrical descriptions of the geometrical area of each parking spot is required. The additional burden on the memory for such a functionality is reasonable: in the worst case scenario, 50 spots are monitored by a single pole (which is a high amount of spots assigned to a pole); if some parking spots are monitored by two poles and if each spot is described by 2 points of 2 words×67,000 (in the Boston example), then the memory requirement range to pre-store the set of geometrical descriptions is under 100 MB of additional data.

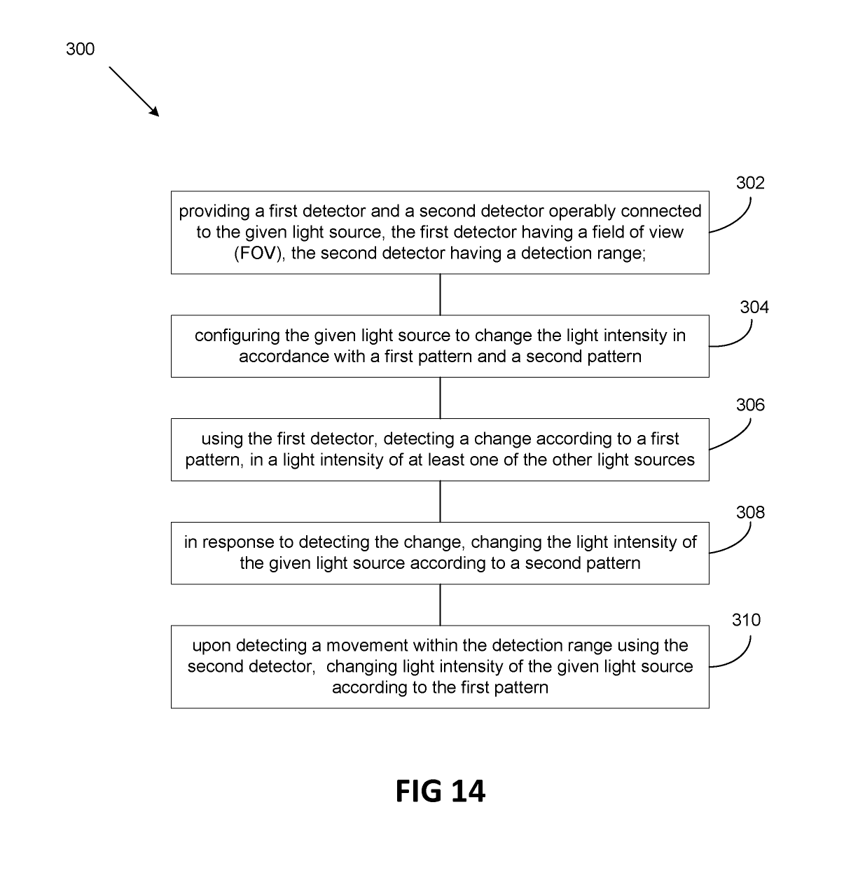

FIG. 14 is a flowchart of a method 300 for controlling a light intensity of a given light source in a light network comprising other light sources, in accordance with an embodiment. The method begins at step 302 by providing a first detector and a second detector operably connected to the given light source, the first detector having a field of view (FOV), the second detector having a detection range. Step 304 comprises configuring the given light source to change the light intensity in accordance with a first pattern and a second pattern. Step 306 comprises, using the first detector, detecting a change according to a first pattern, in a light intensity of at least one of the other light sources. Step 308 comprises, in response to detecting the change, changing the light intensity of the given light source according to a second pattern. At step 310, upon detecting a movement within the detection range using the second detector, the method comprises changing light intensity of the given light source according to the first pattern.

While preferred embodiments have been described above and illustrated in the accompanying drawings, it will be evident to those skilled in the art that modifications may be made without departing from this disclosure. Such modifications are considered as possible variants comprised in the scope of the disclosure.

1. A method for controlling a light intensity of a given light source in a light network comprising other light sources, the method comprising:
providing a first detector and a second detector operably connected to the given light source, the first detector having a field of view (FOV), the second detector having a detection range;
configuring the given light source to change the light intensity in accordance with a first pattern and a second pattern;
using the first detector, detecting a change according to a first pattern, in a light intensity of at least one of the other light sources;
in response to detecting the change, changing the light intensity of the given light source according to a second pattern;
wherein upon detecting a movement within the detection range using the second detector, changing light intensity of the given light source according to the first pattern.

2. The method of claim 1, wherein changing the light intensity of the given light source according to the first pattern comprises:
changing light intensity to an intermediate level,
waiting for a predetermined time period, and
increasing the light intensity to an upper level.

3. The method of claim 1, wherein changing the light intensity of the given light source according to the second pattern comprises directly increasing the light intensity to an upper level.

4. The method of claim 1, further comprising, upon changing the light intensity of the given light source according to the first pattern or the second pattern, changing the light intensity of the given light source back to an initial state after a predetermined time interval.

5. The method of claim 1, further comprising, upon changing the light intensity of the given light source according to the first pattern, changing the light intensity of the given light source back to an initial state after a time interval determined from the movement in the FOV.

6. The method of claim 5, further comprising measuring a speed of an object causing the movement in the FOV, wherein changing the light intensity of the given light source back to an initial state occurs after a time interval calculated from the speed of the object.

7. The method of claim 1, wherein the first detector and the second detector are an imaging device.

8. The method of claim 1, wherein providing a first detector comprises providing an imaging device and providing a second detector comprises providing a microphone.

9. The method of claim 8, further comprising exchanging data collected by the second detector with the other light sources and using exchanged data for determining a location of the movement.

10. The method of claim 1, further comprising adjusting the first pattern and the second pattern according to at least one of: time, season, weather, and a notification of an occurring event.

11. An apparatus for controlling a light intensity of a given light source in a light network comprising other light sources, the apparatus comprising:
a camera having a field of view (FOV) and being configured for acquiring images of the FOV;
a control unit, operably connected to the camera and to the given light source, for controlling the light intensity of the given light source, the control unit being adapted to:
receive images of the FOV from the camera and analyze the received images for performing at least one of:
detecting a movement in the FOV; and
detecting a change, according to a first pattern, in the light intensity of the at least one of the other light sources; and
upon detecting a movement in the FOV, change light intensity of the given light source according to the first pattern; and
upon detecting a change, according to the first pattern, in the light intensity of the at least one of the other light sources, change the light intensity of the given light source according to a second pattern.

12. The apparatus of claim 11, wherein the apparatus is adapted to control the light intensity of the given light source comprising a plurality of individual light source elements, wherein the controller is adapted to individually control the light intensity of the plurality of light sources within the given light source.

13. The apparatus of claim 11, further comprising a vibration sensor operably connected to the control unit to detect a low frequency vibration, wherein the control unit is adapted to monitor the detected vibration for an encoded signal which changes a mode of operation of the control unit.

14. A system for controlling a network of light sources, the system comprising:
a plurality of apparatuses, each one of the apparatuses being installed on a corresponding one of the light sources and being to control a light intensity of the corresponding one of the light sources in accordance with a first pattern and a second pattern, wherein each one of the light sources has a field of illumination (FOI); and each one of the apparatuses has a field of view (FOV) substantially covering the FOI of the corresponding one of the light sources and covering at least in part the FOI of at least another one of the light sources;
each one of the apparatuses comprising:
a first detector adapted to detect a movement inside its FOV;
a second detector adapted to detect a change according to the first pattern in the FOI of the at least another one of the light sources;
a controller operably connected to the first detector, to the second detector, and to the corresponding one of the light sources, the controller being adapted to:
upon detecting a movement in the FOV, change the light intensity of the corresponding one of the light sources according to the first pattern; and
upon detecting a change, according to the first pattern, in the light intensity of the at least another one of the light sources, change the light intensity of the corresponding one of the light sources according to a second pattern.

15. The system of claim 14, wherein the detector for detecting a movement inside its FOV comprises a microphone.

16. The system of claim 15, wherein each one of the apparatuses further comprises an enclosure, wherein the enclosure acts as a membrane for the microphone.

17. The system of claim 14, wherein the detector for detecting a movement inside its FOV and the detector for detecting a change in the FOI are the same detector, which comprises a camera.

18. The system of claim 17, wherein each one of the apparatuses further comprises a communication module operably connected to the controller to allow apparatuses to share data.

19. The system of claim 18, wherein the controller of each one of the apparatuses is adapted to extract features of the movement, wherein the communication module of one of the apparatuses is adapted to exchange the features with at least another one of the apparatuses.

20. An apparatus for controlling a light intensity of a given light source in a light network comprising other apparatuses, the apparatus comprising:
a microphone having a detection range and being adapted to collect sound data from a sound source located within the detection range;
a communication module adapted to receive external data from at least one of the other apparatuses;
a control unit, operably connected to the microphone, to the communication module and to the given light source, for controlling the light intensity of the given light source, the control unit being adapted to:
receive sound data from the microphone and external data from the communication module;
compare the sound data and the external data to determine a location of the source; and
if the sound source is determined to be closer to the apparatus than to any one of the other apparatuses, change the light intensity of the given light source to an operating mode.

21. The apparatus of claim 20, further comprising a frequency filter to spectrally filter the sound data to determine a nature of the sound source.

22. The apparatus of claim 20, further comprising an enclosure for the apparatus, wherein the enclosure acts as a membrane for the microphone.

23. The apparatus of claim 20, wherein the apparatus is for installation on a pole, wherein the microphone is adapted to detect a vibration of the pole, wherein the control unit is adapted to monitor the detected vibration of the pole for an encoded signal which changes a mode of operation of the control unit.

24. The apparatus of claim 23, wherein the encoded signal comprises information about an abnormal condition of operation.
